(19) United States
(12) Patent Application Publication
(10) Pub. No.: US 2006/0007671 A1
(43) Pub. Date: Jan. 12, 2006

(54) Ski goggles with lightining device

(76) Inventor: David Lavoie, Laval (CA)

Correspondence Address: DAVID LAVOIE, 1942 DUMOUCHEL # 03, LAVAL, QC, H75 1J8, CA

(21) Appl. No.: 10/924,127

(22) Filed: Aug. 24, 2004

(30) Foreign Application Priority Data
Jul. 6, 2004 (CA) 2 472 413

(51) Int. Cl. F21V 21/08

(52) U.S. Cl. 362/103

(57) ABSTRACT

Ski goggles were always used to protect skiers eyes, to improve their sight and to add an element of esthetism to the skier's apparel. Ski goggles are often used during the winter season. As it is known, winter days are usually shorter, therefore it gets dark outside much earlier. This is why in the present invention, the ski goggles are provided with L.E.D. (light emitting diode) which optimizes the vision of the skier enormously. From now on, ski goggles are not passive anymore, they become active and modify the environment of its user. They light up all, the obstacles that are in front of skier. Not only he sees better the other skiers who surround him, but they also noticed his presence right away and that causes to avoid painful collisions and falls. Moreover, with the multitude of lights and colors available, there are numbers of ways of placing them on the goggles; that accentuates the differences between the clothes of the skiers. Even within a kilometer, it is possible for you to distinguish your friend from other skiers. The concept of goggles explained here is made up of a wire which has a function of bringing the electricity of the battery to the goggles. This wire can also be used as a bond between the coat of the skier and the goggles, therefore they are never out of reach of the skier.

### BACKGROUND OF THE INVENTION

The present invention is referred to as a ski apparel that is used to protect the eyes and illuminates the landscape which surrounds the sportsman who has the goggles described here.

Ski goggles were always used to protect skiers eyes, to improve their sight and to add an element of esthetism to a ski apparel. They protect the eyes from the snow, the cold, tree branches and the various projectiles that are susceptible to wound the eyes. They improve the sight with the various kinds of lenses, from their colors or their polarities, which optimizes the landscapes that surround the skiers. The forms, the colors and the attributes of this pair of goggles gives its owner the best look because the first thing people notice in strangers is their face. As mentioned before, ordinary goggles are passive because they do not modify the environment of its user. Moreover, they do not usually have any reliable bond with the skier. Which means that in case that they fall out of the user's head, without the wire, they will end up far from him.

### PAST PATENTS

U.S. Pat. No. 4,254,451

3 MAR 1981

SEQUENTIAL FLASHING DEVICE FOR PERSONNAL ORNAMENTATION

JAMES A. COCHRAN JR.

U.S. Pat. No. 6,390,640 B1

21 MAY 2002

LIGHTED MASK FOR UNDERWATER DIVERS

KEVIN WONG

U.S. Pat. No. 6,554,444 B2

29 APR 2003

GAZING POINT ILLUMINATING DEVICE

JUN-ICHI SRIMADA

THESE PATENTS HAVE A RESEMBLANCE TO THE PRESENT REQUEST, BUT THE FIELDS, THE UTILITIES AS WELL AS THE CLAIMS HAVE NOTHING TO DO WITH THIS PRESENT INVENTION EXPLAINED HERE.

### SUMMARY OF THE INVENTION

Ski goggles are very often used during the winter season. As it is known, the winter days are usually shorter, therefore it gets dark outside much earlier. This is why in the present invention, the ski goggles are provided with lights (L.E.D.) which optimize the vision of the skier enormously. They are not passive anymore, they become active and modify the environment of its user. They light up all the obstacles in front of the skier. Not only he sees better the other skiers who surround him, but they also noticed his presence right away and that avoid painful collisions and falls. Also, with the multitude of lights and colors available, there are numbers of ways of placing them on the goggles, that accentuates the differences between the clothes of the skiers. Even with a kilometer, it is possible for you to distinguish your friend from other skiers. Normally, that would not be possible with a regular pair of goggles. Another advantage to consider: it frequently happens that while falling on the track or by removing the goggles to clean them in the chair-lifts, that the goggles of the skier fall and end up far from him. The skier must thus turn over to seek them. This can be a very unpleasant situation. The concept of goggles explained here are made up of a wire which brings the electricity of the battery to the goggles. This wire can also be used as reliable bond between the coat of the skier and the goggles, therefore they are never out of reach of the skier.

### DESCRIPTION OF THE DRAWINGS

Accordingly to the drawings which illustrate the realization of the invention:

FIG. 1 is a back view of a realization

FIG. 2 is a back view of the aforementioned realization with an addition

FIG. 3 is a back view of the aforementioned realization (picture)

FIG. 4 is a front view of the aforementioned realization (picture)

FIG. 5 is a top view of the aforementioned realization (picture)

FIG. 6 is a closer front view of the aforementioned realization (picture)

### DETAILED DESCRIPTION OF THE INVENTION

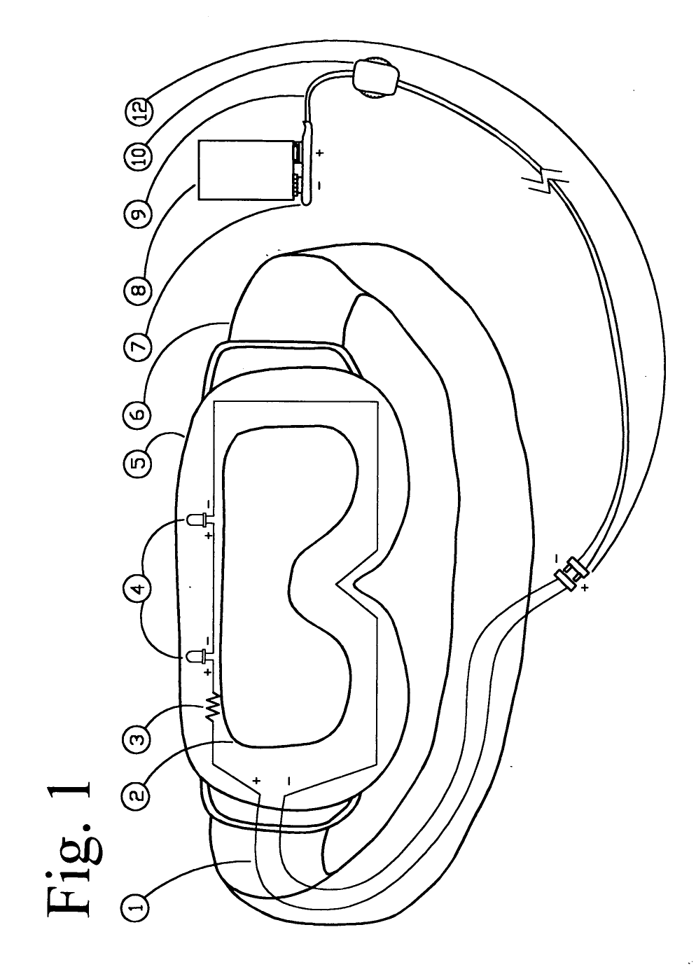

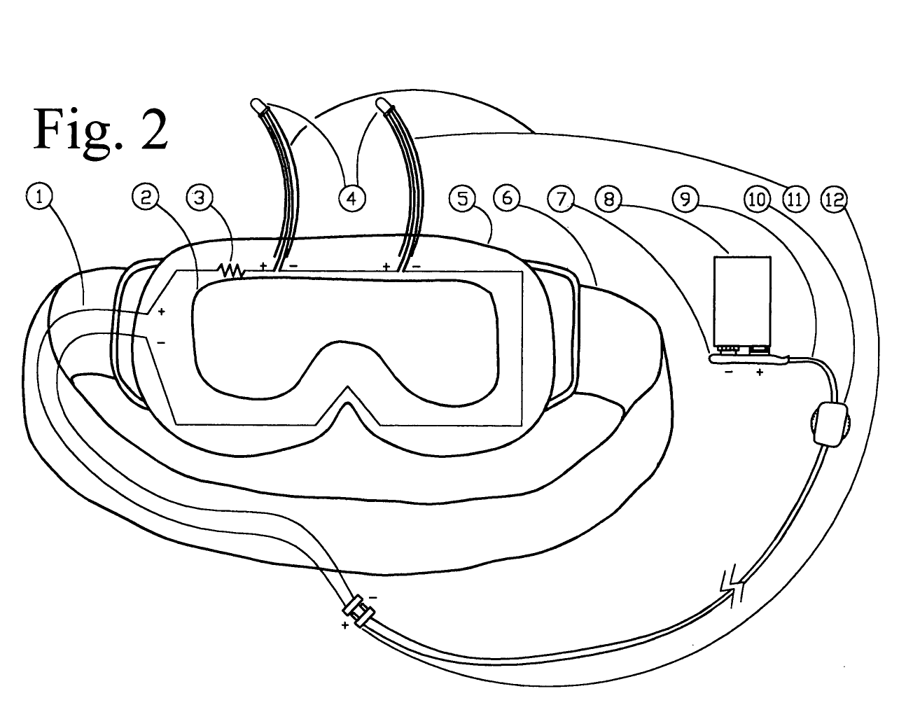

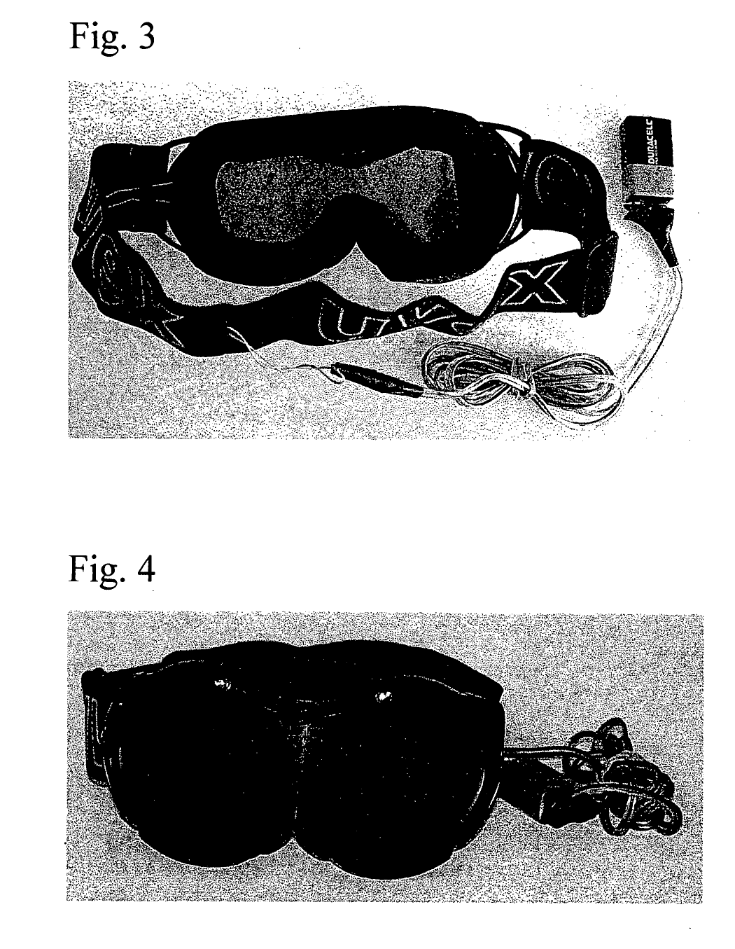

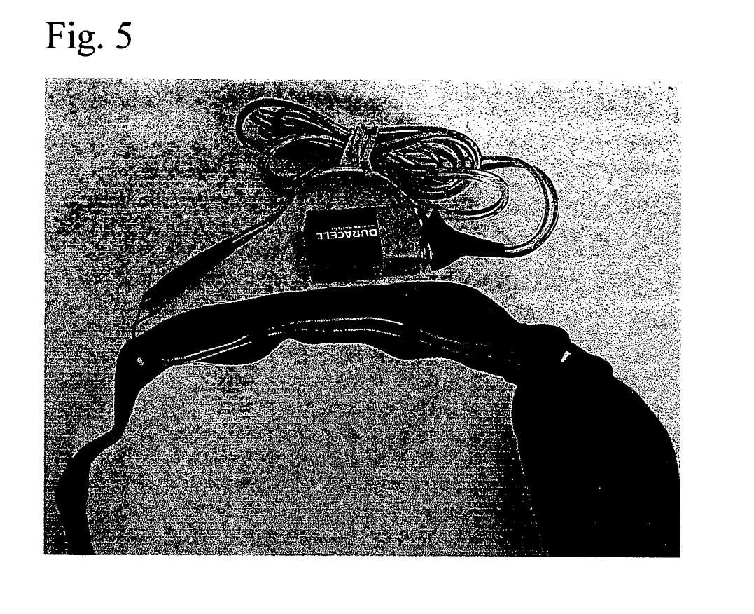

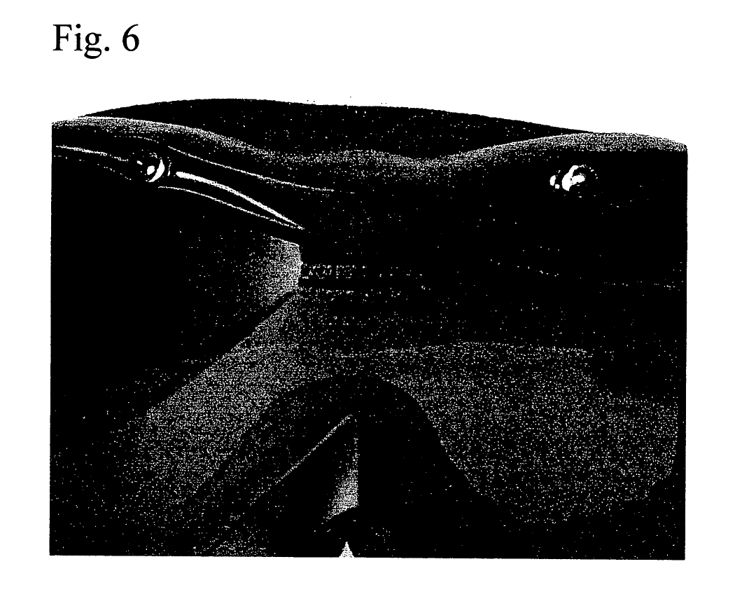

The illustrated goggles (FIG. 1 to 6) holds a source of electricity, in this case, a 9V battery #8. It is preferable that it is placed elsewhere than on the goggles to avoid wounds due to an head impact resulting from a fall. Moreover, the choice of the 9V battery was made according to the time of use. It is also possible to insert miniature battery (as for watches) in mounting #5, but it's complicated and ineffective compared to the time of use. This battery #8 is connected with a connector #7 for a 9V battery. A double multistranded wire 14ga #9 (generally used for speakers) is welded with connector #7. A few inches further, a switch with caster #10 is connected to wire #9. This one is used to light up and extinguish the L.E.D. The caster is easily controllable with winter gloves. Moreover, the caster does not turn alone, contrary to a switch button which could be turned on or off by inadvertency. Wire #9 continues its path for a distance of 137 cm (4,5 feet) towards the male part of the connector #12 made out of plastic with two iron stitches. This connector is welded to the double wire #9 and its purpose is to make it possible for the user to separate himself from the wire and the battery if he does not wish to use it anymore. Winter coats are often equipped with an internal pocket which is located around chest area on the left or right hand side. If the user places the battery in this pocket, there shouldn't be any problems. Otherwise, if he does not have that, he must place it in his trousers pocket. The length of the wire #9 becomes important. This is why the wire length is 4,5 feet. This length suits everyone, no matter their size. Moreover, a small additional length was added to avoid any undesirable tension (stretching) of the wire. Otherwise, the tension would cause a lack of comfort to the user and would weaken the electric system with time. After the male part, there is the female part of connector #12. This one is connected with the goggles because it does not have an iron stitch which can wound the user if he falls, contrary with the male part. A monobrin wire 22ga #1 is then welded with the positive terminal of the female part of the connector #12. This wire passes by the elastic band #6 and goes to the top of the interior of mounting #5. At this place, the wire #1 is connected with a resistance #3. To know the value of the resistance which should be connected here, a little further see the table of values as well as the formula which follows it. The First L.E.D. #4 is connected by its positive leg to resistance #3. Then, the negative leg is connected with the positive leg of the other L.E.D. #4. With the result that they are in series. If ever other L.E.D. were to be laid out on the goggles, they could be added to this series in the same way that the two following ones are connected. The wire #1 leaves the negative leg of the second L.E.D., makes the contour of the bottom of mounting #5, without passing in front of lens #2, and turns towards the negative terminal of the connector #12 while passing by elastic band #6. Wire #1 holds easily on mounting #5 and the head band #6 with drops of hot glue, small plastic hooks or fitting holes. L.E.D. #4 are placed in holes of their size in mounting #5. Moreover, it is preferable to give them an angle of roughly 10° towards outside vertically and 15° towards outside horizontally. The goal is not to blind somebody who looks in the eyes of the user. There is another way of placing lights #4, one is to place them at the end of springs or stems #11 (FIG. 2). The purpose of these springs is to imitate the antennas of a bee. So when the user's head moves, the springs and the L.E.D. move like antennas. This kind of goggles is aimed at a younger public. It is also possible to place the L.E.D. so that they light up mounting #5 itself. By doing so it looks like the goggles were made like neons. One can even put a plastic object in front of the L.E.D, so that the object illuminates. For example a heart, a death's-head or a company's logo. This plastic object can even be retractable. It can be provided with plastic stitch which can enter holes made for this purpose in mounting #5. This improve the esthetism. The choice of L.E.D. increases a lot the time of use with only one 9V battery. For example, with 4 L.E.D. (total of 7,6V, 20 mA and 152 mW), it's possible to use them during more than 16 hours (see the graph of discharge for a 9V battery a little further). Imagine now that at a rate of a few hours per day of skiing, it is possible to use 2 L.E.D. during a whole season of ski, without changing the battery. That is why it is better to use L.E.D. then ordinary lights (incandescent). Those who need more power, therefore they make that the battery lasts less longer. They waste a too great part of this power in heat. It as should be noted this system adds only 80 grams (2,9 oz) to the goggles.

TABLE OF CARACTERISTICS ON VARIOUS L.E.D.

| | | | | | | | Vf (v) | | Iv (mcd) | | View | Normal | Normal | Resistance |
|---|---|---|---|---|---|---|---|---|---|---|---|---|---|---|
| | | | | Chip | | Lens | @20 mA | | @20 mA | | angle | Voltage | Current | needed (Ω) |
| Size | | Color | Part No. | Material | λP(nm) | Color | Min. | Max. | Min. | Typ. | 2Θ½ | (ν) | (mA) | for 2 leds |
| 3 | mm | Red | LUE2043 | AlGalnP | 620 | Clear | 1.7 | 2.8 | 1100 | 1800 | 30 | 1.9 | 20 | 260 |
| | | Yellow | LHY12243 | AlGalnP | 595 | Clear | 1.7 | 2.8 | 1100 | 2200 | 20 | 1.9 | 20 | 260 |
| | | Green | LDGM2043 | InGan | 523 | Clear | 3.0 | 4.0 | 1500 | 2700 | 30 | 3.3 | 20 | 120 |
| | | Blue | LDBK2043 | GalnN/GaN | 470 | Clear | 3.0 | 4.0 | 90 | 1100 | 30 | 3.3 | 20 | 120 |
| | | Purple | LDUV2043 | InGan | 400 | Clear | 3.0 | 4.0 | 65 | 110 | 30 | 3.4 | 20 | 110 |
| | | White | LWK2043 | GalnN/GaN | — | Clear | 3.0 | 4.0 | 160 | 2200 | 30 | 3.6 | 20 | 90 |
| 5 | mm | Red | LUR3333/S46 | GaAlAs | 660 | Clear | 1.5 | 2.4 | 900 | 1800 | 30 | 1.9 | 20 | 260 |
| | | Yellow | LUY3333/S46 | AlGalnP | 595 | Clear | 1.7 | 2.8 | 1100 | 2200 | 30 | 1.9 | 20 | 260 |
| | | Green | LUG3333/S46 | AlGalnP | 574 | Clear | 1.7 | 2.8 | 350 | 550 | 30 | 3.3 | 20 | 120 |
| | | Blue | LSBK3333 | InGaN/SiC | 468 | Clear | 3.0 | 4.0 | 550 | 900 | 15 | 3.3 | 20 | 120 |
| | | Purple | LDUV3333 | InGaN | 400 | Clear | 3.0 | 4.0 | 160 | 300 | 20 | 3.4 | 20 | 110 |
| | | White | LWK3333-50 | InGaN/GaN | — | Clear | 3.5 | 4.0 | 550 | 900 | 50 | 3.6 | 20 | 90 |
| | | Orange | LUE3333 | AlGalnP | 620 | Clear | 1.7 | 2.8 | 1800 | 3400 | 20 | 2 | 20 | 250 |
| 10 | mm | Red | LUR13633 | GaAlAs | 660 | Clear | 1.5 | 2.4 | 1500 | 3000 | 12 | 1.9 | 20 | 260 |
| | | Yellow | LUY13633 | AlGalnP | 595 | Clear | 1.7 | 2.8 | 1500 | 3000 | 12 | 2.2 | 20 | 230 |
| | | Green | LVG13633 | GaP | 565 | Clear | 1.7 | 2.8 | 400 | 700 | 12 | 2.2 | 20 | 230 |

(Values are a reference taken in the data of the Ligitek company)

Mathematical formula to know which resistance #3 is necessary to put in the series circuit (FIGS. 1 & 2):
Source=Voltage of the source (V)
Nb led=Number of L.E.D. to install
V led=Voltage of a L.E.D. (V)
A led=Amperage of a L.E.D. (mA)
   (Source−(Nb led×V led))/(A led/1000)=(Ω)
   Ex: (9V−(2×1,9V))/(20 mA/1000)=260 Ω)
Note: This formula can be used to find resistance necessary in a circuit containing other kinds of light than L.E.D. You only have to insert the right values.

[image]

1. Ski goggles with lightning device made up with:
(Those goggles are known as ski goggles, but they are used in several other sports:snowboarding, snowmobile, paint-ball . . . Sometimes, goggles include parts that turn them into masks.)
(a) some elements usually used in a pair of goggles of this type: a mounting, a lens and an elastic band;
(b) one or more sources of light of all kinds, all the colors, all twinkling forms or not, covered with retractable transparent decorative objects or not, placed anywhere on the goggles or maintained around this one by one or more stems, tubes or springs;
(c) one or more sources of electricity of any kind and of all intensities that can be made to be more or less close to the aforementioned goggles, and can be connected with the lights with a wire provided with a switch, a connector and a resistance.
